(19) United States
(12) Patent Application Publication
(10) Pub. No.: US 2007/0177412 A1
(43) Pub. Date: Aug. 2, 2007

(54) Charge pumped driver for switched mode power supply

(75) Inventor: Gordon Sharp, Edinburgh (GB)

Correspondence Address: BRIAN M BERLINER, ESQ;O'MELVENY & MYERS, LLP, 400 SOUTH HOPE STREET, LOS ANGELES, CA, 90071-2899, US

(73) Assignee: POWER-ONE, INC.

(21) Appl. No.: 11/344,695

(22) Filed: Jan. 31, 2006

(51) Int. Cl. H02M 3/18

(52) U.S. Cl. 363/59

(57) ABSTRACT

A driver circuit provides a driving signal to the power stage of a switched mode power supply in correspondence with a pulse width modulated duty cycle. A voltage doubler circuit including a bucket capacitor and plural switches is arranged to successively couple the bucket capacitor to the input power source and to the driver circuit. The voltage doubler circuit thereby provides the driving signal to the driver circuit having a voltage approximately double the corresponding voltage of the input power source. The voltage doubler circuit discharges the bucket capacitor into the driver circuit to provide the driving signal in correspondence with a first portion of the pulse width modulated duty cycle, and the voltage doubler circuit recharges the bucket capacitor in correspondence with a second portion of the pulse width modulated duty cycle. The power switch comprises an internal capacitance, wherein charge stored in the bucket capacitor is transferred to the internal capacitance of the at least one power switch during the first portion of the pulse width modulated duty cycle. Remaining charge in the internal capacitance of the power switch is recycled back to the bucket capacitor during the second portion of the pulse width modulated duty cycle.

### BACKGROUND OF THE INVENTION

1. Field of the Invention

The present invention relates to switched mode power supplies, and more particularly to a charge pumped driver for a switched mode power supply that is adapted for implementation in a monolithic semiconductor device.

2. Description of Related Art

Switched mode power supplies are known in the art to convert an available direct current (DC) level voltage to another DC level voltage. A buck converter is one particular type of switched mode power supply that delivers a regulated DC output voltage to a load by selectively storing energy in an output inductor coupled to the load by switching the flow of current into the output inductor. The buck converter includes two power switches, referred to as high side and low side switches, that are typically provided by MOSFET transistors. The high side switch couples the output inductor to a positive supply voltage, and the low side switch couples the output inductor to ground. A pulse width modulation (PWM) control circuit is used to control the gating of the high and low side switches in an alternating manner to control the flow of current in the output inductor. The PWM control circuit uses signals communicated via a feedback loop reflecting the output voltage and/or current level to adjust the duty cycle applied to the power switches in response to changing load conditions.

For many low voltage applications, it is necessary to increase the gate drive voltage applied to the power switches in order to ensure good conduction of the power switches. A charge pump is a type of circuit used in such applications to provide a boosted regulated supply voltage to the power switch drivers. As known in the art, a charge pump typically comprises a switching matrix controlled by a timing circuit to successively charge and discharge one or more capacitors, and thereby produce a higher effective drive voltage that is in turn delivered to a driver circuit that provides the gate drive voltage to the power switches.

The current trend in the art is to reduce the size of the switched mode power supply so that it could be located in close proximity to the circuitry that is being powered. Accordingly, it is desirable to be able to implement the switched mode power supply and related circuitry in a monolithic semiconductor package. Nevertheless, a drawback of the known arrangement of charge pump and driver is that the various circuit components, particularly the capacitors, are not conducive for implementation in such a monolithic semiconductor device. Moreover, one approach to minimizing the size of the switched mode power supply is to greatly increase the switching frequency of the power switches, which thereby enables a reduction in the size of the output inductor. At the same time, however, the higher switching frequency causes greater switching losses and a resulting reduction in efficiency.

It is therefore desirable to provide a charge pumped driver for a switched mode power supply that is adapted for implementation in a monolithic semiconductor device. It is further desirable to be able to recover some of the energy from the power switches in order to boost the efficiency of the switched mode power supply.

### SUMMARY OF THE INVENTION

The present invention satisfies the need for a low voltage switched mode power supply charge pumped driver implementation adapted for a monolithic solution and that enables improved efficiency operation. The switched mode power supply comprises a power stage having at least one power switch coupled to an input power source.

In an embodiment of the invention, a driver circuit provides a driving signal to the power stage in correspondence with a pulse width modulated duty cycle. A voltage doubler circuit including a bucket capacitor and plural switches is arranged to successively couple the bucket capacitor to the input power source and to the driver circuit. The voltage doubler circuit thereby provides the driving signal to the driver circuit having a voltage approximately double the corresponding voltage of the input power source. The voltage doubler circuit discharges the bucket capacitor into the driver circuit to provide the driving signal in correspondence with a first portion of the pulse width modulated duty cycle, and the voltage doubler circuit recharges the bucket capacitor in correspondence with a second portion of the pulse width modulated duty cycle. The power switch comprises an internal capacitance, wherein charge stored in the bucket capacitor is transferred to the internal capacitance of the at least one power switch during the first portion of the pulse width modulated duty cycle. Remaining charge in the internal capacitance of the power switch is recycled back to the bucket capacitor during the second portion of the pulse width modulated duty cycle.

When the power switch comprises a low side power switch of a power stage, the driver circuit may be adapted to provide a driving signal to the power switch that is referenced to ground. Alternatively, when the power switch comprises a high side power switch of a power stage, the driver circuit may be adapted to provide a driving signal to the power switch that is floating with respect to ground. The voltage doubler may also be selectively disabled for applications in which the input voltage is suitable to drive the power switches directly through the driver circuit.

In another embodiment of the invention, a method of controlling a switched mode power supply comprises (a) discharging a bucket capacitor to provide a driving signal to at least one power switch in correspondence with a first portion of a pulse width modulated duty cycle, the driving signal having a voltage approximately double the corresponding voltage of the input power source, and (b) recharging the bucket capacitor in correspondence with a second portion of the pulse width modulated duty cycle. The discharging step further comprises coupling the bucket capacitor in series with the input power source to the at least one power switch. The recharging step further comprises partially recycling charge from an internal capacitance of the power switch back to the bucket capacitor, and then coupling the bucket capacitor in parallel with the input power source.

A more complete understanding of a charge pumped driver for a switched mode power supply that is adapted for implementation in a monolithic semiconductor device will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIG. 1 depicts a charge pumped driver implementation for a switched mode power stage in accordance with the prior art;

FIGS. 2A and 2B depict the direction of current flow during successive charging and transfer phases of the conventional charge pump of FIG. 1;

FIG. 3 depicts a charge pumped driver implementation for a switched mode power stage in accordance with an embodiment of the present invention;

FIGS. 4A, 4B and 4C depict the direction of current flow during successive driving, recycling, and recharging phases of the charged pump driver of FIG. 3;

FIGS. 5A, 5B and 5C depicts the voltage waveform applied to the power stage during time periods A, B and C corresponding to FIGS. 4A, 4B and 4C, respectively;

FIG. 6 depicts a charge pumped driver implementation for a switched mode power stage in accordance with an alternative embodiment of the present invention;

FIG. 7 depicts corresponding voltage waveforms measured at various points within the charge pumped driver of FIG. 6; and

FIG. 8 depicts a charge pumped driver implementation for a switched mode power stage in accordance with an alternative embodiment of the present invention.

### DETAILED DESCRIPTION OF THE PREFERRED EMBODIMENT

The present invention provides a charge pumped driver for a switched mode power supply. In the detailed description that follows, like element numerals are used to describe like elements illustrated in one or more figures.

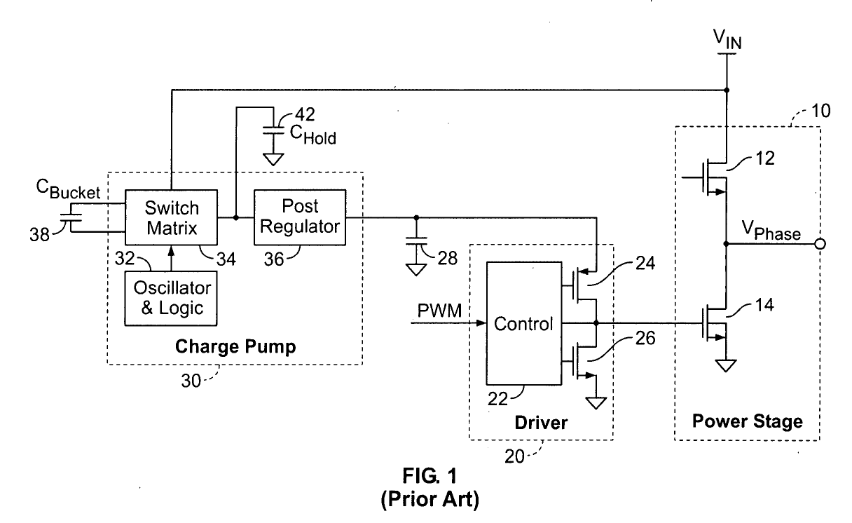

FIG. 1 illustrates an example of a conventional power stage drive topology used in low voltage applications. The topology includes a power stage 10, a driver 20 and a charge pump 30. The power stage comprises the high side and low side power switches 12, 14 of a switched mode power supply. The power switches 12, 14 are coupled together in series between an input voltage V_{IN} and ground, with a phase node V_{PHASE} defined therebetween. The phase node V_{PHASE} is typically coupled to a load through an output inductor (not shown). The gate terminals of the high side and low side power switches 12, 14 are driven by the driver 20, which is in turn driven at a desired duty cycle by a PWM control circuit (not shown). It should be appreciated that the high side and low side power switches 12, 14 are driven out of phase with respect to each other. As shown in FIG. 1, the power switches 12, 14 are provided by power MOSFET devices.

The driver 20 further comprises a control circuit 22 and MOSFETs 24, 26 coupled in series in a “push-pull” configuration. The source terminal of p-channel MOSFET 24 is coupled to a drive voltage across capacitor 28. The drain terminal of MOSFET 24 is coupled to the drain terminal of n-channel MOSFET 26, and also to the gate terminal of power switch 14. The source terminal of MOSFET 26 is coupled to ground. The control circuit 22 converts the duty cycle from the PWM control circuit to suitable gate voltages for controlling the MOSFETs 24, 26. When MOSFET 24 is turned on and MOSFET 26 is turned off by the control circuit 22, current will pass through MOSFET 24 but not through MOSFET 26 so that current is “pushed” to the gate terminal of power switch 14, thereby producing a positive voltage across the gate terminal. When MOSFET 24 is turned off and MOSFET 26 is turned on by the control circuit 22, current will pass through MOSFET 26 but not through MOSFET 24 so that current is “pulled” from the gate terminal of power switch 14, thereby grounding the gate terminal.

The charge pump 30 includes an oscillator 32, switching matrix 34, and post regulation circuit 36. The oscillator 32 provides a clock signal to control the gating of switches contained within the switching matrix 34 in order to successively charge and discharge a bucket capacitor (C_{Bucket}) 38. The operation of the switching matrix 34 causes the input voltage V_{IN} to be increased to a higher value, which is then stored in holding capacitor (C_{Hold}) 42. The post regulation circuit 36 reduces noise or ripple of the voltage stored in the holding capacitor 42, and provides the regulated voltage to the driver 20.

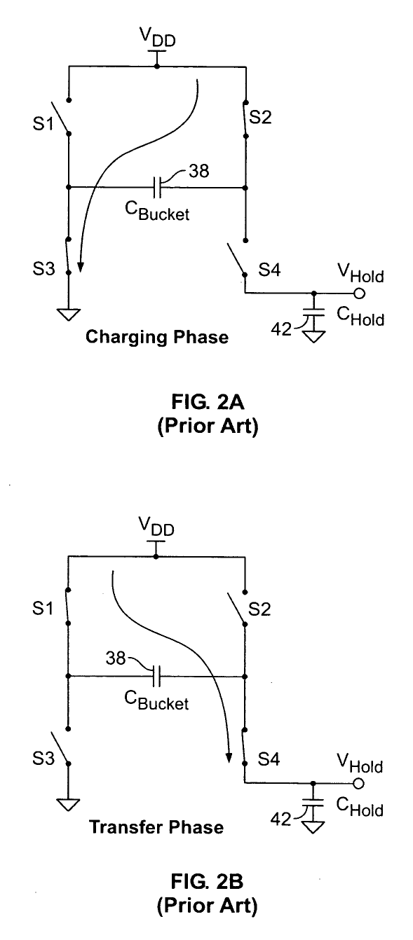

The operation of the switching matrix 34 is further illustrated with respect to FIGS. 2A and 2B. In both figures, the switching matrix 34 is represented as four switches (S1, S2, S3, S4). Switches S1, S3 are connected in series between an input voltage (VDD) and ground. Switches S2, S4 are connected in series between an input voltage and the holding capacitor (C_{Hold}) 42. The bucket capacitor (C_{Bucket}) 38 is connected between the junctions of switches S1, S3 and S2, S4. The switches are activated by the oscillator 32, which runs at roughly 50% duty cycle.

FIG. 2A shows a charging phase of the switching matrix 34 during the first half of the oscillator frequency period, in which switches S2 and S3 are closed and switches S1 and S4 are opened. The bucket capacitor 38 is charged by current flowing through the path defined by switches S2, S3 and the bucket capacitor. Ideally, the bucket capacitor 38 is charged to the input voltage (VDD). FIG. 2B shows a transfer phase of the switching matrix 34 during the second half of the oscillator frequency period, in which switches S2 and S3 are opened and switches S1 and S4 are closed. The bucket capacitor 38 is discharged, and the holding capacitor 42 is charged by current flowing through the path defined by switches S2, S3 and the bucket capacitor. The voltage of the holding capacitor 42 is ideally equal to the sum of the voltage of the bucket capacitor 38 and the input voltage (VDD), which are now coupled in series. In other words, the holding capacitor 42 is charged to a voltage equal to roughly double the input voltage (VDD). It should be understood that the actual voltage of the holding capacitor at the end of the transfer phase will be a little less than double the input voltage (VDD) due to losses of the switches and charging losses of the bucket capacitor 38.

As discussed above, the charge pumped driver implementation of FIG. 1 is not optimal for monolithic solutions in terms of silicon area, noise and power efficiency. The circuit implementation of the present invention overcomes this drawback of the prior art.

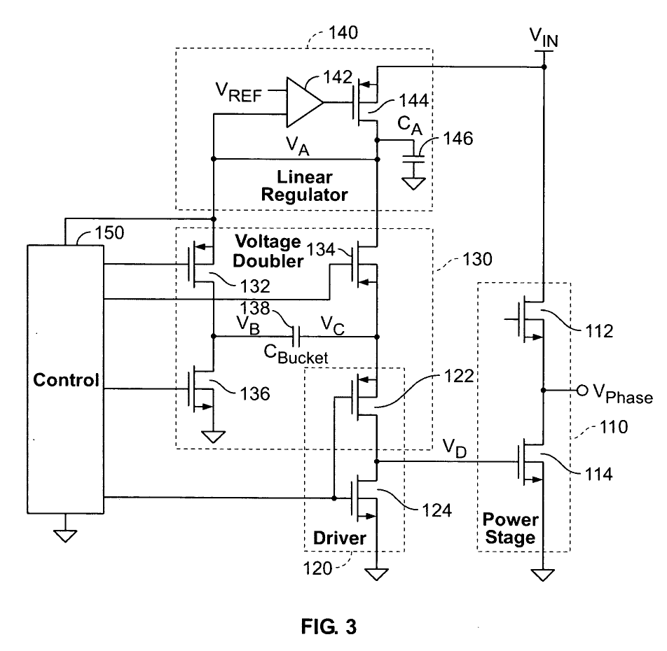

Referring now to FIG. 3, a charge pumped driver implementation is shown for a switched mode power stage in accordance with an embodiment of the present invention. The charge pumped driver implementation includes a power stage 110, a driver 120, a voltage doubler 130, a linear regulator 140, and a control circuit 150. As in FIG. 1, the power stage 110 comprises the high side and low side power switches 112, 114 of a switched mode power supply. The power switches 112, 114 are coupled together in series between an input voltage V_{IN} and ground, with a phase node V_{PHASE} defined therebetween. The phase node V_{PHASE} is typically coupled to a load through an output inductor (not shown). In the preferred embodiment, the power switches 112, 114 are provided by power FET devices, though other suitable switching devices could also be utilized.

The linear regulator 140 includes an operational amplifier 142, a p-channel MOSFET 144, and capacitor (CA) 146. The output terminal of the operational amplifier 142 drives the gate terminal of the MOSFET 144, with a unity-gain feedback path defined between the output terminal and one of the input terminals of the operational amplifier. A reference voltage (V_{REF}) may be applied to the other input terminal of the operation amplifier 142, which causes the operational amplifier to regulate the gate voltage applied to the MOSFET 144 so that the voltage at the drain terminal of the MOSFET tracks the reference voltage. This drain voltage provides the input voltage for the voltage doubler 130. The capacitor 146 reduces noise or ripple of the input voltage as well as noise caused by the driver 120 changing state. The linear regulator 140 enables a range of input voltages for the charge pumped driver down to roughly one-half of the required gate drive voltage for the power switches. For certain low input voltage applications, it should be appreciated that the linear regulator 140 may be omitted altogether.

Unlike the circuit of FIG. 1, the present invention incorporates the driver 120 and voltage doubler 130 together. The voltage doubler 130 is used to double the regulated voltage supply in order to provide an optimal gate drive voltage for the power stage switches. As shown in FIG. 3, the voltage doubler 130 comprises MOSFETs 132, 134, 136 and bucket capacitor 138. The MOSFETs and bucket capacitor are arranged similar to the switching network described above. MOSFETs 132, 136 are connected in series between the input voltage and ground. MOSFET 134 is connected in series with the driver 120 between the input voltage and ground. The bucket capacitor 138 is connected between the junctions of switches MOSFETs 132, 136 and MOSFET 134, driver 120. The MOSFETs and the driver are activated by the control circuit 150. The driver 120 includes MOSFETs 122, 124 coupled in series in a “push-pull” configuration similar to that of FIG. 1 described above.

The driver 120 provides a dual role in the present charge pumped driver. In addition to the driving the power stage switches, the driver 120 also provides the function of the fourth switch (S4) and the holding capacitor of the aforementioned switching matrix. This is achieved by controlling the timing of operation of the driver 120 and voltage doubler 130 so that the doubling action occurs during the turn-on period of the driver and the bucket capacitor 138 is charged during the turn-off period of the driver. Hence, there would be no ripple control requirements and the filtering elements (i.e., capacitors) can be eliminated. The gate capacitance of the power switches is used as the holding capacitor for the charge pump. By using the driver source transistor in combination with the hold transistor of the charge pump, the transistor count and associated silicon area can be significantly reduced.

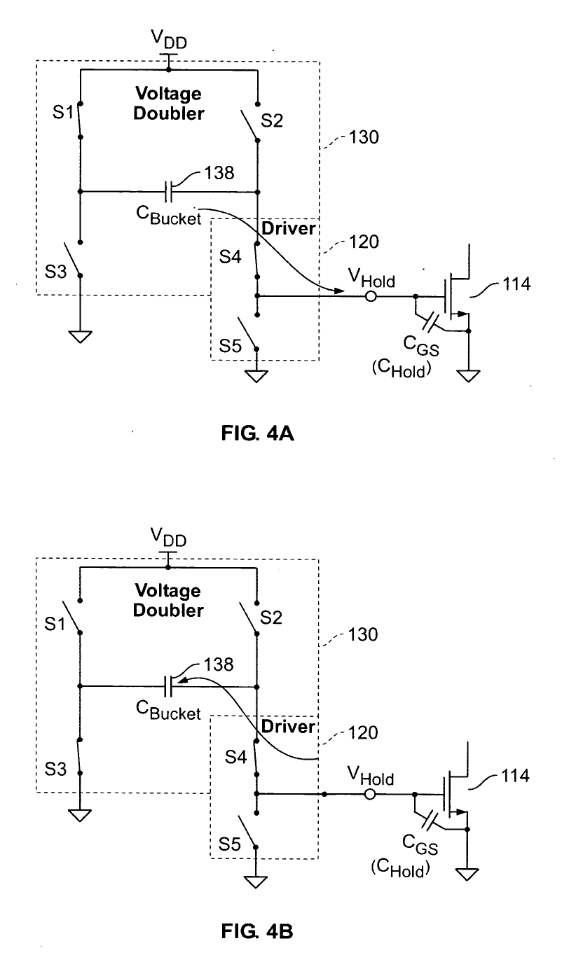

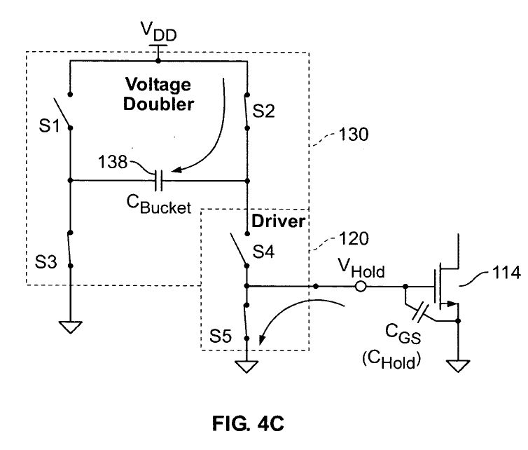

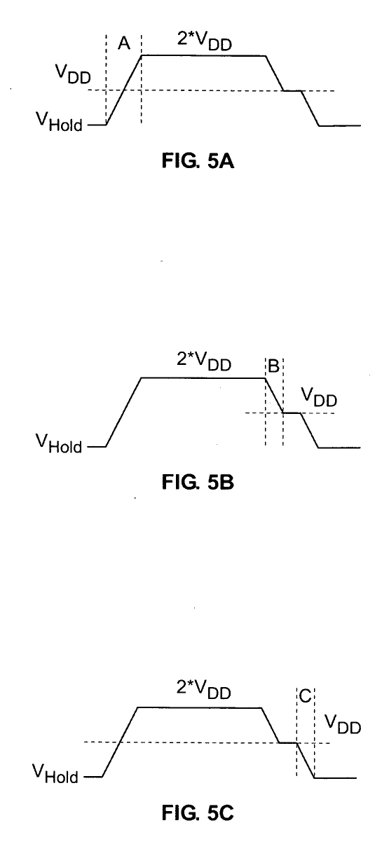

The operation of the present charge pumped driver is illustrated with respect to FIGS. 4A-4C and 5A-5C. In FIGS. 4A-4C, MOSFET 132 is depicted as switch S1; MOSFET 134 is depicted as switch S2; MOSFET 136 is depicted as switch S3; MOSFET 122 is depicted as switch S4; and MOSFET 124 is depicted as switch S5. The internal gate-source capacitance of power switch 114 is depicted as a holding capacitor (C_{Hold}).

FIGS. 4A and 5A depict the drive transition period A of the charge pumped driver. Switches S1 and S4 are closed during this period, and switches S2, S3 and S5 are open. Charge sharing is performed between the bucket capacitor (C_{Bucket}) 138 and the holding capacitor (C_{Hold}) in which the charge on the bucket capacitor is transferred to the holding capacitor through switch S4. It should be appreciated that the bucket capacitor will normally be much larger than the holding capacitor in order to reduce the voltage drop. The transition period is depicted by time A in the voltage waveform of FIG. 5A, and reflects a ramp up in voltage to a level corresponding to roughly double the input voltage (i.e., 2*VDD). Hence, charge-pump doubling occurs simultaneously with the turn-on of the power switch 114.

FIGS. 4B and 5B depict the drive transition period B of the charge pumped driver. Switches S3 and S4 are closed during this period, and switches S1, S2 and S5 are open. Roughly half of the remaining charge on the holding capacitor is transferred back to the bucket capacitor through switch S4. The transition period is depicted by time B in the voltage waveform of FIG. 5B, and reflects a ramp down in voltage to a level corresponding to the input voltage (i.e., VDD). It should be appreciated that the efficiency of the charge pumped driver is improved by recycling the stored energy of the holding capacitor.

FIGS. 4C and 5C depict the drive transition period C of the charge pumped driver. After transition period B, switch S4 is opened and switch S5 is closed to allow the remaining charge on the holding capacitor to discharge through switch S5. Switch S2 is then closed (along with switch S3 closed during transition period B) to allow the bucket capacitor 138 to be charged by the input voltage (VDD) through a path that includes switches S2 and S3. The transition period is depicted by time C in the voltage waveform of FIG. 5C, and reflects a further ramp down in voltage below the level corresponding to the input voltage (i.e., VDD).

The charge pumped driver of FIG. 3 reduces the transistor count/silicon area by combining the charge pump switching matrix with the driver stage. Further, the design requires no oscillator and very little control logic, resulting in further silicon area savings. The charge pumped driver provides several power efficiency advantages over the conventional circuitry. First, up to one-half of the power switch gate charge can be recycled back to the bucket capacitor. This could represent a considerable efficiency improvement when high capacitive transistors are driven at high frequencies. Second, by clocking the charge pump only when required by transitions of the PWM duty cycle, there is considerable efficiency savings by minimizing the gate charge and shoot-through switching losses.

In applications in which the input voltage is sufficient to drive the power switches of the power stage without requiring the charge pumped driver, the control circuit 150 can maintain MOSFET 134 in a constantly on state and MOSFETs 132, 136 in a constantly off state. This would essentially bypass operation of the voltage doubler 130 altogether. The control circuit 150 can thereby control operation of the power switches 112, 114 through the driver 120. This way, the same charge pumped driver circuit can be used in applications that require voltage doubling or not.

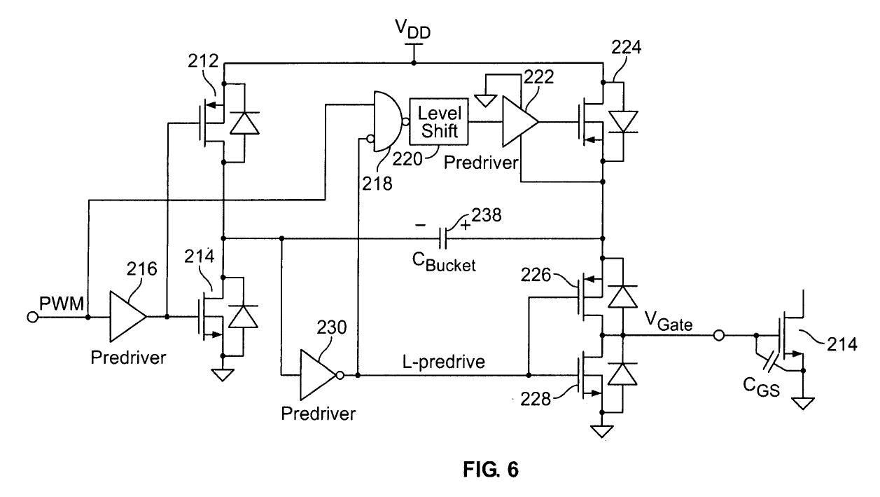

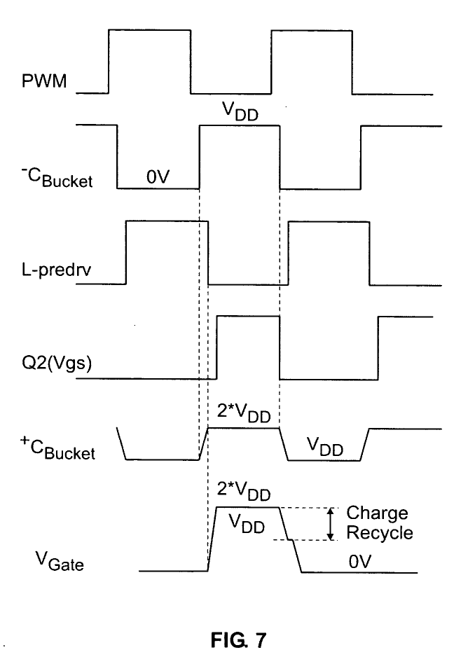

Referring now to FIG. 6, a MOSFET implementation for the charge pumped driver is depicted in accordance with an alternative embodiment of the invention. The charge pumped driver includes MOSFETs 212, 224, 214, 226, and 228, corresponding to switches S1, S2, S3, S4, and S5 of the preceding embodiment. The MOSFETs are driven using transitions of the PWM duty cycle, thereby eliminating an oscillator and associated control logic. The gate terminals of MOSFETS 212 (S1) and 214 (S3) are driven by the PWM duty cycle through a suitable predriver 216, such that MOSFET 212 is turned on during a negative portion of the PWM duty cycle and MOSFET 214 is turned on by a positive portion of the PWM duty cycle. The gate terminals of MOSFETs 226 (S4), 228 (S5) are driven by the inverse of the junction voltage between MOSFETs 212, 214 through suitable inverting predriver 230, such that MOSFET 226 is turned on after the start of the positive portion of the PWM duty cycle and remains on until after the start of the negative portion of the PWM duty cycle. The gate terminal of MOSFET 224 is driven by a circuit that includes NAND gate 218, level shifter 220 and predriver 222, so that MOSFET 224 (S2) is turned on only when MOSFETs 212 (S1) and 226 (S4) are turned off. FIG. 7 depicts corresponding voltage waveforms measured at various points within the charge pumped driver of FIG. 6.

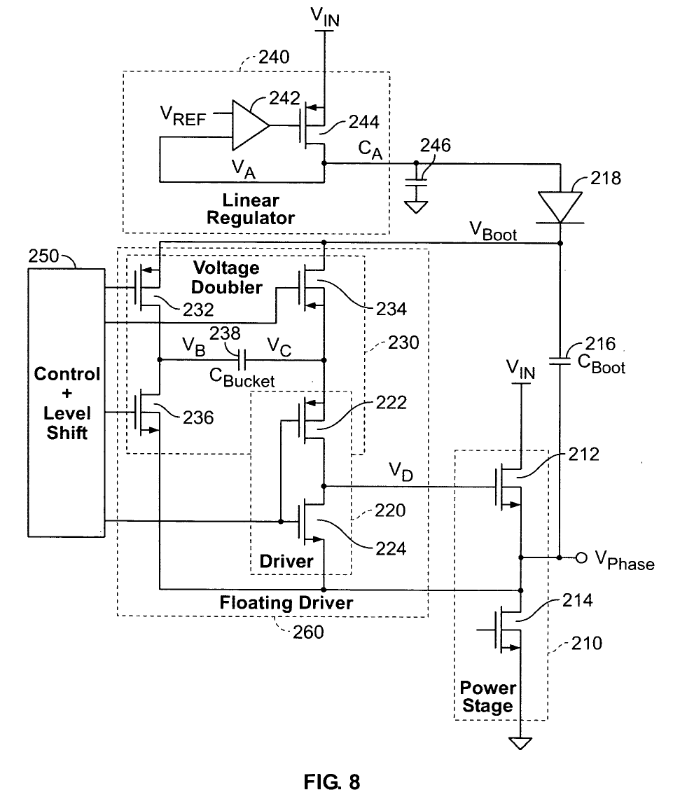

FIG. 8 depicts a charge pumped driver implementation for a switched mode power stage in accordance with an alternative embodiment of the present invention. While the charge pumped driver of FIG. 3 provided driving signals for the low side switch of the power stage that are referenced to ground, the alternative charge pumped driver of FIG. 8 provides driving signals for the high side switch of the power stage that are floating. The charge pumped driver implementation includes a power stage 210, a driver 220, a voltage doubler 230, a linear regulator 240, and a control circuit 250. The voltage doubler 230 and driver 220 combine to provide a floating driver 260. As in FIGS. 1 and 3, the power stage 210 comprises the high side and low side power switches 212, 214 of a switched mode power supply. The power switches 212, 214 are coupled together in series between an input voltage V_{IN} and ground, with a phase node V_{PHASE} defined therebetween.

The linear regulator 240 is substantially the same as the linear regulator 140 of FIG. 3, and includes an operational amplifier 242, a p-channel MOSFET 244, and capacitor (CA) 246. The voltage at the drain terminal of the MOSFET 244 tracks the reference voltage and provides the input voltage (V_{Boot}) for the voltage doubler 230 through diode 218. The input voltage V_{Boot} is referenced to the phase voltage (V_{Phase}) across capacitor 216 (C_{Boot}). For certain low input voltage applications, it should be appreciated that the linear regulator 240 may be omitted altogether.

As with the circuit of FIG. 3, the driver 220 and voltage doubler 230 are combined together. The voltage doubler 230 is used to double the regulated voltage supply in order to provide an optimal gate drive voltage for the power stage switches, and comprises MOSFETs 232, 234, 236 and bucket capacitor 238. MOSFETs 232, 236 are connected in series between the input boot voltage and a floating ground defined by the phase voltage V_{Phase}. MOSFET 234 is connected in series with the driver 220 between the input voltage and the floating ground. The bucket capacitor 238 is connected between the junctions of switches MOSFETs 232, 236 and MOSFET 234, driver 220. The MOSFETs and the driver are activated by the control circuit 250. The driver 220 includes MOSFETs 222, 224 coupled in series in a “push-pull” configuration as in FIG. 3 described above.

As in FIG. 3, the control circuit 250 controls the timing of operation of the driver 220 and voltage doubler 230 so that the doubling action occurs during the turn-on period of the driver and the bucket capacitor 238 is charged during the turn-off period of the driver. The gate capacitance of the power switches is used as the holding capacitor for the charge pump. By using the driver source transistor in combination with the hold transistor of the charge pump, the transistor count and associated silicon area can be significantly reduced.

In applications in which the input voltage is sufficient to drive the power switches of the power stage without requiring the charge pumped driver, the control circuit 250 can maintain MOSFET 234 in a constantly on state and MOSFETs 232, 236 in a constantly off state. This would essentially bypass operation of the voltage doubler 230 altogether. The control circuit 250 can thereby control operation of the power switches 212, 214 through the driver 220. This way, the same charge pumped driver circuit can be used in applications that require voltage doubling or not.

Having thus described a preferred embodiment of a charge pumped driver for a switched mode power supply, it should be apparent to those skilled in the art that certain advantages of the system have been achieved. It should also be appreciated that various modifications, adaptations, and alternative embodiments thereof may be made within the scope and spirit of the present invention. The invention is further defined by the following claims.

What is claimed is:

1. A switched mode power supply comprising:
a power stage having at least one power switch adapted to apply a voltage from an input power source to a load;
a driver circuit providing a driving signal to the power stage in correspondence with a pulse width modulated duty cycle; and
a voltage doubler circuit including a bucket capacitor and plural switches arranged to successively couple the bucket capacitor to the input power source and to the driver circuit, the voltage doubler circuit thereby providing the driving signal to the driver circuit having a voltage approximately double the corresponding voltage of the input power source;
wherein, the voltage doubler circuit at least partially discharges the bucket capacitor into the driver circuit to provide the driving signal in correspondence with a first portion of the pulse width modulated duty cycle and the voltage doubler circuit recharges the bucket capacitor in correspondence with a second portion of the pulse width modulated duty cycle.

2. The switched mode power supply of claim 1, wherein said at least one power switch comprises an internal capacitance, and wherein charge stored in the bucket capacitor is transferred to the internal capacitance of the at least one power switch during the first portion of the pulse width modulated duty cycle.

3. The switched mode power supply of claim 2, wherein remaining charge in the internal capacitance of the at least one power switch is at least partially recycled back to the bucket capacitor during the second portion of the pulse width modulated duty cycle.

4. The switched mode power supply of claim 1, further comprising a linear regulator operatively coupled to the input power source and the voltage doubler circuit, the linear regulator adapted to regulate the input power source prior to delivery to the voltage doubler circuit.

5. The switched mode power supply of claim 1, wherein the first portion of the pulse width modulated duty cycle comprises a turn-on period of the at least one power switch.

6. The switched mode power supply of claim 5, wherein the second portion of the pulse width modulated duty cycle comprises a turn-off period of the at least one power switch.

7. The switched mode power supply of claim 1, wherein at least one of the plural switches of the voltage doubler circuit is activated by the pulse width modulated duty cycle.

8. The switched mode power supply of claim 1, wherein the at least one power switch further comprises a low side switch of the power stage, the driving signal provided by the driver circuit being referenced to ground.

9. The switched mode power supply of claim 1, wherein the at least one power switch further comprises a high side switch of the power stage, the driving signal provided by the driver circuit being floating with respect to ground.

10. The switched mode power supply of claim 1, further comprising means for selectively disabling the voltage doubler circuit to permit the driver circuit to drive the at least one power switch at a level corresponding to the input voltage.

11. In a switched mode power supply comprising a power stage having at least one power switch adapted to apply a voltage from an input power source to a load, a charge pumped driver comprises:
a driver circuit providing a driving signal to the power stage in correspondence with a pulse width modulated duty cycle; and
a voltage doubler circuit including a bucket capacitor and plural switches arranged to successively couple the bucket capacitor to the input power source and to the driver circuit, the voltage doubler circuit thereby providing the driving signal to the driver circuit having a voltage approximately double the corresponding voltage of the input power source;
wherein, the voltage doubler circuit at least partially discharges the bucket capacitor into the driver circuit to provide the driving signal in correspondence with a first portion of the pulse width modulated duty cycle and the voltage doubler circuit recharges the bucket capacitor in correspondence with a second portion of the pulse width modulated duty cycle.

12. The charge pumped driver of claim 11, wherein said at least one power switch comprises an internal capacitance, and wherein charge stored in the bucket capacitor is transferred to the internal capacitance of the at least one power switch during the first portion of the pulse width modulated duty cycle.

13. The charge pumped driver of claim 12, wherein remaining charge in the internal capacitance of the at least one power switch is at least partially recycled back to the bucket capacitor during the second portion of the pulse width modulated duty cycle.

14. The charge pumped driver of claim 11, further comprising a linear regulator operatively coupled to the input power source and the voltage doubler circuit, the linear regulator adapted to regulate the input power source prior to delivery to the voltage doubler circuit.

15. The charge pumped driver of claim 11, wherein the first portion of the pulse width modulated duty cycle comprises a turn-on period of the at least one power switch.

16. The charge pumped driver of claim 15, wherein the second portion of the pulse width modulated duty cycle comprises a turn-off period of the at least one power switch.

17. The charge pumped driver of claim 11, wherein at least one of the plural switches of the voltage doubler circuit is activated by the pulse width modulated duty cycle.

18. The charge pumped driver of claim 11, wherein the at least one power switch further comprises a low side switch of the power stage, the driving signal provided by the driver circuit being referenced to ground.

19. The charged pumped driver of claim 11, wherein the at least one power switch further comprises a high side switch of the power stage, the driving signal provided by the driver circuit being floating with respect to ground.

20. The charge pumped driver of claim 11, further comprising means for selectively disabling the voltage doubler circuit to permit the driver circuit to drive the at least one power switch at a level corresponding to the input voltage.

21. A method of controlling a switched mode power supply comprising a power stage having at least one power switch coupled to an input power source, said method comprising:
discharging a bucket capacitor to provide a driving signal to the at least one power switch in correspondence with a first portion of a pulse width modulated duty cycle, the driving signal having a voltage approximately double the corresponding voltage of the input power source; and
recharging the bucket capacitor in correspondence with a second portion of the pulse width modulated duty cycle.

22. The method of claim 21, wherein said discharging step further comprises coupling the bucket capacitor in series with the input power source to the at least one power switch.

23. The method of claim 21, wherein said recharging step further comprises recycling remaining charge from an internal capacitance of the at least one power switch back to the bucket capacitor.

24. The method of claim 21, wherein said recharging step further comprises coupling the bucket capacitor in parallel with the input power source.

25. The method of claim 21, further comprising regulating the input power source to a voltage less than the input power source.

26. The method of claim 21, wherein the first portion of the pulse width modulated duty cycle comprises a turn-on period of the at least one power switch.

27. The method of claim 26, wherein the second portion of the pulse width modulated duty cycle comprises a turn-off period of the at least one power switch.
